(19) United States
(12) Patent Application Publication
(10) Pub. No.: US 2007/0182070 A1
(43) Pub. Date: Aug. 9, 2007

(54) USE OF POLYMER POWDER PRODUCED FROM A DISPERSION IN A SHAPING PROCESS, AND MOLDINGS PRODUCED FROM THIS POLYMER POWDER

(75) Inventors: Sylvia MONSHEIMER, Haltern am See (DE); Maik Grebe, Bochum (DE); Hideki Matsui, Himeji (JP); Hajime Komada, Himeji (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 11/671,820

(22) Filed: Feb. 6, 2007

(30) Foreign Application Priority Data
Feb. 7, 2006 (DE) 10 2006 005 500.4

(51) Int. Cl. B29C 35/08; B29C 41/02

(52) U.S. Cl. 264/497; 264/460; 264/113

(57) ABSTRACT

Three-dimensional shaped products are prepared by a layer-by-layer moldless production process in which at least one powder layer is provided, regions of the respective powder layer are selective melted via input of electromagnetic energy, wherein the powder of the powder layer contains at least one polymer powder or copolymer powder produced from a dispersion which contains at least one polymer or copolymer and which contains a water-soluble component, the water-soluble component containing at least one oligosaccharide.

### BACKGROUND OF THE INVENTION

1. Field of the Invention

The present invention relates to the use of a polymer powder, produced from a dispersion, in shaping processes, and also to moldings produced via a layer-by-layer process, by selective melting of regions of a powder layer, using this power.

2. Discussion of the Background

Rapid production of prototypes is a task frequently encountered in very recent times. Particularly suitable processes here are those whose operation is based on pulverulent materials and in which the desired structures are produced layer-by-layer via selective melting and hardening. Support structures for overhangs and undercuts can be omitted in these processes, because the powder bed surrounding the molten regions provides sufficient support. The subsequent operation of removing supports is likewise not needed. The processes are also suitable for small-run production.

One process which has particular suitability for the purposes of rapid prototyping is selective laser sintering. This process uses a laser beam for selective brief irradiation of plastics powders in a chamber, the result being melting of the powder particles impacted by the laser beam. The molten particles coalesce and rapidly solidify again to give a solid mass. This process can produce three-dimensional products in a simple and rapid fashion via repeated irradiation of successive freshly applied layers.

The patent specifications U.S. Pat. No. 6,136,948 and WO 96/06881 (both DTM Corporation) give a detailed description of the laser sintering (rapid prototyping) process for production of shaped products from pulverulent polymers. A wide variety of polymers and copolymers is claimed for this application, examples being polyacetate, polypropylene, polyethylene, ionomers, and polyamide.

Other process with good suitability are the SIB process, as described in WO 01/38061, or a process as described in EP 1 015 214. Both processes operate with full-surface infrared heating to melt the polymer. Selectivity of melting is achieved in the first via application of an inhibitor and in the second process via a mask. DE 103 11 438 describes another process. In this, the energy needed for melting is introduced via a microwave generator, and selectivity is achieved via application of a susceptor.

Other suitable processes are those which operate with an absorber, either present in the powder or applied by inkjet methods, as described in DE 10 2004 012 682.8, DE 10 2004 012 683.6, and DE 10 2004 020 452.7.

The rapid prototyping or rapid manufacturing processes (RP or RM processes) mentioned can use pulverulent substrates, in particular polymers, preferably selected from polyester, polyvinyl chloride, polyacetal, polypropylene, polyethylene, polystyrene, polycarbonate, poly(N-methylmethacrylimides) (PMMI), polymethyl methacrylate (PMMA), ionomer, polyamide, or a mixture thereof.

WO 95/11006 describes a polymer powder which is suitable for laser sintering and which, when melting behavior is determined via differential scanning calorimetry, using a scanning rate of from 10 to 20° C./min, exhibits no overlapping of the melting peak and recrystallization peak, and which has a degree of crystallinity of from 10 to 90%, likewise determined via DSC, and has a number-average molecular weight Mn of from 30 000 to 500 000, and has a M_{w}/Mₙ quotient in the range from 1 to 5.

DE 197 47 309 describes the use of nylon-12 powder with increased melting point and increased enthalpy of fusion, obtained via reprecipitation of a polyamide previously produced via ring-opening and subsequent polycondensation of laurolactam. This is a nylon-12.

A disadvantage with all of the processes is that it is necessary to use powder with relatively round grain shape. This restricts the selection of materials available. For example, it is disadvantageous to use a material obtained via milling, because the sharp edges of the particles give rise to poor powder-flow properties. This makes an automatic construction process more difficult because grooves constantly occur when the powder layers are applied, and in the worst case lead to stoppage of the constructional process, but in every case impair the quality of the resultant components, in particular density and surface quality.

Other processes for production of round particles are restricted to a few materials for other reasons. An example which may be mentioned is anionic polymerization, which generates a poorly defined product and moreover does not permit addition of additives such as stabilizers before the preparational production process has ended.

The precipitation process as described in DE1 9747309 also requires solubility of the polymer in a solvent and capability for precipitation under suitable conditions. The methods described cannot give amorphous polymers or copolymers in the form of a powder with round particles. The same restrictions apply to polymers which are insoluble or have low solubility, for example PBT.

Another difficulty arises when additives, such as flame retardants or impact modifiers, have to be present in the powder. The amounts of these needed in the final product are usually above 1% by weight in order to achieve the desired effect; this generally excludes processes such as anionic polymerization, or a precipitation process. The two components are separately converted to powder form and then dry-blended, the resultant disadvantage is that this does not achieve good and thorough mixing of the components, and indeed no interactive effects can arise. By way of example, for impact modification it is advantageous for the impact-resistant component to couple to the base polymer. Another risk posed by a dry-blended mixture during processing by a rapid prototyping or rapid manufacturing process as described above is phase separating of the two components, particularly if the nature of the particles differs greatly or their density differs markedly.

Production of a compounded material and subsequent low-temperature milling does not lead to satisfactory results, for a number of specific reasons. Firstly, the compounding process itself can damage the polymers and also the additives. Secondly, low-temperature milling is, as a function of polymer or additive, a highly inefficient process, and commercialization of a powder produced by this method is therefore impossible. By way of example here, mention may be made of impact-modifying polymers in which the impact modifier leads to very low yield—irrespective of whether it has coupled to the polymer during the compounding process or not—values that may be mentioned by way of example being less than 30%. Other polymers that are very difficult to mill are polymers in the upper end of the molecular-weight range within their polymer class, but this is specifically advantageous for mechanical properties.

### SUMMARY OF THE INVENTION

It is therefore an object of the present invention to find a way of producing parts from polymers and, respectively, copolymers not previously available in round-grain form and with sufficiently fine grain size. The process here is a layer-by-layer process with selective melting of regions of the respective powder layer using electromagnetic energy, where these have bonded after cooling to give the desired shaped product.

This and other objects have been achieved by the present invention the first embodiment of which includes a process for the layer-by-layer moldless production of three-dimensional shaped products, comprising:

providing at least one powder layer,

selective melting of regions of the respective powder layer via input of electromagnetic energy,

wherein said powder of said powder layer comprises at least one polymer powder or copolymer powder produced from a dispersion which comprises at least one polymer or copolymer and which comprises a water-soluble component,

said water-soluble component comprising at least one oligosaccharide.

### BRIEF DESCRIPTION OF DRAWINGS

FIG. 1 is a scanning electron micrograph of the particles of comparative example 1.

FIG. 2 is a scanning electron micrograph of the particles of example 1.

### DETAILED DESCRIPTION OF THE INVENTION

The present invention relates to the use of a polymer powder, produced from a dispersion, in shaping processes, and also to moldings produced via a layer-by-layer process, by selective melting of regions of a powder layer, using this power. After cooling and hardening of the regions previously melted layer-by-layer, the shaped product can be removed from the powder bed.

By way of example, selectivity of the layer-by-layer processes here can be achieved by way of application of susceptors, or of absorbers or inhibitors, or via masks, or by way of focused introduction of energy, for example via a laser beam, or by way of glass fibers, or via selective application of the powder. Energy input is achieved by way of electromagnetic radiation.

Surprisingly, it has now been found, that when polymer powders produced from a dispersion are used in a layer-by-layer process, by selective melting of regions of the respective powder layer, it is possible to produce shaped parts, and that this process can process almost any polymer or copolymer reliably. The dispersion comprises at least one polymer component and one water-soluble auxiliary component, and the auxiliary component here in turn comprises at least one oligosaccharide. Use of powder produced from a dispersion as described above means that formulations hitherto capable of preparation only via the traditional methods, such as low-temperature grinding, can be converted via the process described above to a pulverulent form in which the particles are sufficiently round to permit automatic processing in a powder-based moldless layer-by-layer process (RP and RM processes as described above).

The present invention therefore provides the use of a polymer powder for processing in a layer-by-layer process, by selective melting of regions of the respective layer, which comprises a process in which the powder has been produced from a dispersion. The particles here do not have any of the sharp edges known to the person skilled in the art by way of example from ground powder. The dispersion comprises at least one polymer component and one water-soluble auxiliary component, which in turn comprises at least one oligosaccharide. EP 1 512 725 describes the production of these powders, and its entire scope is incorporated by way of reference into the present invention. The same applies to Japanese patent application JP 2005-156460, submitted on 27 May 2005, title: “Production method of resin particles”.

An advantage of using polymer powder prepared from a dispersion is that shaped products produced from the powder via a layer-by-layer process, by selective melting of regions of the respective layer, can comprise polymers and, respectively, copolymers which were hitherto not processable in the abovementioned processes. Properties quite different to those previously possible can thus be obtained. By way of example, copolymers or amorphous polymers can now be used in the processes described, in order to achieve transparency or impact resistance in the shaped products.

The polymer powder and its inventive use are described below, but there is no intention to restrict the present invention to that description. The term polymer is to be interpreted in this description as including copolymers.

A feature of the polymer powder for processing in a layer-by-layer process by selective melting of regions of the respective layer is that the powder has been produced from a dispersion which comprises at least one polymer component and one water-soluble auxiliary component, where the auxiliary component in turn comprises at least one oligosaccharide.

The Polymer Component

The polymer component comprises a polymer insoluble in water, or a thermoplastic polymer, or a thermoset, or else a combination thereof. Examples of the thermoplastic polymer are polycondensates, such as polyesters, aliphatic or aromatic, polyamides, copolyamides, polyurethanes, poly(thio)ethers, polycarbonate, polysulfone, polyimide, and also polymers such as polyolefins, methacrylates, polystyrene, vinyl-based polymers, and also products which are derived from natural substances, for example cellulose derivatives. Copolymers may also be mentioned. An example of the thermoset is provided by epoxy resins, unsaturated polyesters, diallyl phthalates, and silicones. Particular mention may be made of thermoplastic elastomers such as those based on polyamide, on polyester, on polyvinyl chloride, or on fluoropolymers. Mention is also made of polyvinyl chloride, polyacetal, polypropylene, polyethylene, polystyrene, polycarbonate, polybutylene terephthalate, polyethylene terephthalate, polysulfone, polyarylene ether, polyurethane, polylactides, polyoxyalkylenes, poly(N-methylmethacrylimides) (PMMI), polymethyl methacrylate (PMMA), ionomer, silicone polymers, terpolymers, acrylonitrile-butadiene-styrene copolymers (ABS), and mixtures thereof.

Water-soluble Auxiliary Component

The water-soluble auxiliary component comprises at least one oligosaccharide. It is used together with the polymer component and together therewith forms a dispersion. In order to adjust the melting point of the oligosaccharide, it is advantageous that the water-soluble component also comprises a plasticizer.

Oligosaccharide

Oligosaccharides can be divided into two groups: firstly homooligosaccharides, resulting from dehydration of from 2 to 10 monosaccharide molecules via glycoside compounds, and secondly heterooligosaccharides, prepared from dehydration of from 2 to 10 molecules of at least 2 different molecules from the group of the monosaccharides and sugar alcohols via glycoside compounds.

The oligosaccharide here encompass disaccharides to decasaccharides, and those used with preference are disaccharides to hexasaccharides. Oligosaccharides are usually solid at room temperature. The material can also be a mixture of various oligosaccharides, with two or more components; the generic term oligosaccharides is used in the text below.

The oligosaccharide preferably comprises a tetrasaccharide.

The oligosaccharides can be a composition obtained from decomposition of polysaccharides. By way of example, the oligosaccharide composition encompasses starch sugars, galactooligosaccharide, sugar compounds, poly(fruit sugars), xylooligosaccharides, soybeanoligosaccharides, chitinoligosaccharides, and chitanoligosaccharides. These formulations can be used individually or in combination.

The oligosaccharides can be of the reducing type (maltose type) or of the non-reducing type (trelahose type). The former is preferred, because of better thermal stability.

Plasticizing Component

The plasticizing component stabilizes the oligosaccharide's viscosity, which can readily shift upward and can cause difficulties in processing. It can be a saccharide or a sugar alcohol, and is optional.

If a saccharide is used, it is preferably a mono- or disaccharide. Mention may also be made of cyclic isomers of monosaccharides. Saccharide derivatives with, by way of example, methyl, acyl, or carbonyl end groups are likewise encompassed. The most important criterion for the plasticizing auxiliary component is plasticizing effect and, respectively, viscosity reduction with respect to the oligosaccharide (internal lubrication).

If a sugar alcohol is used, it can have linear or cyclic structure, the former being preferred. An example of the sugar alcohol is provided by tetritol, pentitol, or hexitol to dodecitol. It is preferable to use erythritol, pentaerythritol, arabitol, ribitol, xylitol, sorbitol, dulcitol, and mannitol. Erythritol, pentaerythritol, or xylitol is particularly preferred.

Other Additives

The dispersion can comprise other additives, if necessary. By way of example, mention may be made of fillers, stabilizers, thickeners, colors (pigments), lubricants, dispersing agents, antistatic agents or flame retardant additives. The fillers can be mica, clay, talc, or else rayon fibers, but there is no intention that the present invention be restricted thereto. Particular mention may be made of glass beads or glass fibers, carbon fibers, which may have been ground, and metal particles.

Process

A process is also described, separating the auxiliary components (B) from the dispersion, the dispersion being used to produce a product (for example from a porous material, or a particle) which comprises a polymer.

The dispersion can be produced by kneading the polymer component with the auxiliary component. The subsequent shape of the particle is often prepared in this process.

The kneading process can be carried out in a conventional kneader (for example in a single- or twin-screw extruder, or in a kneader or calander). The time needed for this can be from 10 seconds to one hour, preferably from 30 seconds to 45 minutes, and particularly preferably from 1 to 13 minutes. It can be advantageous to convert the polymer component and the auxiliary component into a powder-like form via low-temperature grinding or preliminary kneading, even before this process begins.

Examples of forming processes by which the product is shaped are extrusion, injection molding, blow molding, or calandering processes. Extrusion or injection molding is preferred on grounds of productivity and simple production. There is no restriction on the shape of the precursor product, and it can have the shape of a particle or pellet, or have a one-dimension shape, such as that of a rod or fiber, or an extrudate, or can have a two-dimensional shape, such as that of a sheet or a foil, or else can have a three-dimensional shape, such as that of a pipe, a cylinder, or a block. For removal of the auxiliary component, it is advantageous to use a one- or two-dimensional shape. The precursor product can also be used to coat another material in a forming process.

It is obvious that the kneading temperature, or the temperature in the forming process, depends on the starting materials used (for example polymer component or auxiliary component). The kneading or forming temperature is preferably from 30 to 300° C., particularly preferably from 110 to 260° C., and particularly preferably from 140 to 240° C. In order to avoid thermal decomposition of the auxiliary component (oligosaccharide and plasticizing component), it is advisable to operate at temperatures of at most 230° C. The kneading or forming temperature includes all values and subvalues therebetween, especially including 40, 50, 60, 70, 80, 90, 100, 110, 120, 130, 140, 150, 160, 170, 180, 190, 200, 210, 220, 230, 240, 250, 260, 270, 280 and 290° C.

The disperse system (a form in which the polymer component and the auxiliary component are present in disperse form) can be generated via cooling of a molten mixture (for example derived from the kneader, or derived from the precursor product), the molten mixture here comprising the polymer component and the auxiliary component. The cooling temperature should be at least 10° C. below the heat distortion temperature of the polymer component, or below the melting or softening point of the auxiliary component.

The cooling time is matched to the polymer component and to the auxiliary component, and another influencing factor is the cooling temperature; by way of example, the cooling time can be within a wide range of from 30 seconds to 20 hours. Examples of preferred times are from 1.5 to 30 minutes. The cooling time includes all values and subvalues therebetween, especially including 1, 2, 4, 6, 8, 10, 12, 14, 16, 18, 20, 22, 24, 26, 28, 30, 35, 40, 45, 50, 55, 60 minutes, 2, 3, 4, 5, 6, 7, 8, 9, 10, 11, 12, 13, 14, 15, 16, 17, 18 and 19 hours.

Particularly in cases where the polymer component and the auxiliary component are mutually compatible, a possible method of obtaining the disperse system utilizes different conditions of surface tension and hardening, for example via crystallization, in order to form the disperse system during the cooling process.

If a porous product or a particle is generated, the average pore size or the particle size can be influenced via appropriate adjustment of compatibility between polymer component and auxiliary component, via the viscosity difference between the components, via the kneading or forming conditions, and via the cooling conditions, thus permitting controlled adjustment to a wide range of pore size and pore distribution or of particle and particle size distribution. Both a porous product and a particle can be produced from an identical formulation of the components via appropriate adjustment of the conditions.

Examples of values for the average pore size or average particle size are from 0.1 μm to 1 mm. The average pore size or average particle size includes all values and subvalues therebetween, especially including 0.5, 1, 5, 10, 50, 100, 200, 300, 400, 500, 600, 700, 800 and 900 μm.

The precursor product or the disperse system is brought into contact with a solution, in order to separate or leach the auxiliary component out from the polymer component. Examples of the solvent are water, water-soluble solvents (alcoholic formulations, such as methanol, ethanol, propanol, isopropanol, or butanol), or else an ether formulation.

The preferred solvent is water, which is inexpensive and environmentally friendly. The auxiliary component can be removed under atmospheric pressure, or under an elevated pressure, or in vacuo. The temperature during removal of the auxiliary component depends on the components, and by way of example is from 10 to 100° C. The temperature includes all values and subvalues therebetween, especially including 20, 30, 40, 50, 60, 70, 80, and 90° C.

The product or particle is, by way of example, collected via filtration or centrifugal force. It is advantageous to minimize any residues of the auxiliary component therein.

There is no limitation on the shape of the product produced via removal of the auxiliary component. The product here can be porous, or else it can be a particle, whose size can be round.

Particles with maximum roundness of shape are advantageous for use in the inventive process.

In order to generate particles whose average grain diameter is from 20 to 120 μm, these being used in the inventive process, it is preferable to operate with the ratio by weight of the polymer component and of the water-soluble auxiliary component of from 1:99 to 35:60. For the same reason, a viscosity ratio of the polymer component and of the water-soluble auxiliary component is adjusted to at least 5:1 at the processing temperatures and at a shear rate of 608 sec⁻¹. Of course, this comparative ratio applies to a temperature at which the polymer component is molten and processable; the temperature dependency of the viscosity of the water-soluble auxiliary component generally follows the Arrhenius law. The average grain diameter includes all values and subvalues therebetween, especially including 30, 40, 50, 60, 70, 80, 90, 100 and 110 μm. The the ratio by weight of the polymer component and of the water-soluble auxiliary component includes all values and subvalues therebetween, especially including 5:95, 10:90, 15:85, 20:80, 25:75 and 30:70.

A precautionary sieving and further classification of the resultant powder then follows, if appropriate. Post-treatment of the particles in a high-speed mixer for further rounding of the particles can also be advantageous. It is mostly to add a powder-flow aid of the prior art.

The person skilled in the art can easily discover the conditions for processing in the inventive powder-based moldless production process via exploratory trials.

The BET surface area of the powder produced from the dispersion is smaller than 10 m²/g, preferably smaller than 3 m²/g, and particularly preferably smaller than 1 m²/g. The median grain diameter D₅₀ is preferably from 20 to 120 μm, preferably from 35 to 100 μm, and particularly preferably from 40 to 70 μm. The median grain diameter D₅₀ includes all values and subvalues therebetween, especially including 30, 40, 50, 60, 70, 80, 90, 100 and 110 μm.

The viscosity of the polymer has to be judged in such a way as to permit good processing in the inventive process. A fairly low-viscosity material is generally more suitable; molecular weights to be preferred for the materials optimized for extrusion are those conventional for the respective polymer in injection molding. The molecular weight of the starting material can alter during conversion into a pulverulent form with the aid of the process described above; deviations upward and also downward have been observed in the experiments.

The grain size distribution of the resultant polymer is relatively broad; D₉₀:D₁₀ is from 3:1 to 15:1, preferably from 4:1 to 10:1. The D₉₀:D₁₀ includes all values and subvalues therebetween, especially including 4:1, 5:1, 6:1, 7:1, 8:1, 9:1, 10:1, 11:1, 12:1, 13:1, and 14:1.

The bulk density of the powder for use in the inventive process is preferably in the range from 300 to 600 g/l. The bulk density of the powder includes all values and subvalues therebetween, especially including 350, 400, 450, 500 and 550 g/l.

The BET surface area is determined via gas adsorption, using the Brunauer, Emmet and Teller principle; the standard utilized is DIN ISO 9277.

Polymer powder for use in an inventive process can moreover comprise auxiliaries and/or fillers and/or other organic or inorganic pigments. By way of example, these auxiliaries can be powder-flow aids, e.g. precipitated and/or fumed silicas. Precipitated silicas are supplied by way of example with the product name Aerosil, with various specifications, via Degussa AG. Inventive polymer powder preferably comprises less than 3% by weight, with preference from 0.001 to 2% by, and very particularly preferably from 0.05 to 1% by weight, of these auxiliaries, based on the entirety of the polymers present. By way of example, the fillers can be glass particles, metal particles, or ceramic particles, e.g. glass beads, steel shot, or metal granules, or foreign pigments, e.g. transition metal oxides. The pigments can by way of example be rutile- (preferably) or anatase-based titanium dioxide particles, or carbon black particles.

Addition of absorbers which can ease processing in the inventive process should also be mentioned here. Addition of carbon black has proven particularly advantageous.

The median particle size of the filler particles here is preferably smaller than or approximately equal to that of the particles of the polymer powder. The median particle size d₅o of the fillers should preferably not exceed the median particle size d₅₀ of the polymer powder by more than 20%, preferably 15%, and very particular preferably 5%. A particular restriction on particle size results from the permissible overall height or layer thickness in the rapid prototyping/rapid manufacturing system.

Inventive polymer powder preferably comprises less than 75% by weight, preferably from 0.001 to 70% by weight, particularly preferably from 0.05 to 50% by weight, and very particularly preferably from 0.5 to 25% by weight, of these fillers, based on the entirety of the polymers present.

If the stated maximum limits for auxiliaries and/or fillers are exceeded, as a function of the filler or auxiliary used the results can be marked impairment of mechanical properties of shaped products produced by means of these polymer powders.

It is also possible to mix conventional polymer powders with polymer powders prepared in a dispersion as described above. This method can prepare powders with a further combination of surface properties. The process for preparation of these mixtures can be found by way of example in DE 34 41 708. A particularly advantageous method here mixes the polymer powder prepared by means of dispersion and having fairly round particle shape with a polymer powder obtained via low-temperature milling whose particles have markedly sharper edges. The polymer powder prepared via the dispersion here acts as a powder-flow aid, and the use of this mixture can therefore avoid the processing difficulties associated with the ground powder. Advantageous mixtures are those comprising at least 30% of polymer powder prepared from a dispersion as described above, and particularly advantageous mixtures are those comprising at least 40% thereof, and very particularly advantageous mixtures are those comprising at least 50% of this polymer powder.

To improve processability, or for further modification of the polymer powder, it can receive additions of inorganic foreign pigments, e.g. transition metal oxides, stabilizers, e.g. phenols, in particular sterically hindered phenols, flow agents, and powder-flow aids, e.g. fumed silicas, or else filler particles. The amount of these substances added to the polymers, based on the total weight of polymers in the polymer powder, is preferably such as to comply with the concentrations stated for fillers and/or auxiliaries for the inventive polymer powders.

The present invention also provides processes for production of shaped products via layer-by-layer processes, by selective melting of regions of the respective layer, using polymer powders, which comprise a process in which these powders have been prepared from a dispersion which comprises at least one polymer component and one water-soluble auxiliary component, where the auxiliary component in turn comprises at least one oligosaccharide.

The energy is introduced via electromagnetic radiation, and selectivity is introduced by way of example via masks, or application of inhibitors, of absorbers or of susceptors, or else via focusing of the radiation, for example via lasers. The electromagnetic radiation encompasses the range from 100 nm to 10 cm, preferably from 400 nm to 10 600 nm, or from 800 to 1060 nm. The source of the radiation can, for example, be a microwave generator, a suitable laser, a radiant heater, or a lamp, or else a combination thereof. Once all of the layers have cooled, the inventive shaped product can be removed.

The examples of these processes below serve for illustration, but there is no intention to restrict the present invention thereto.

Laser sintering processes are well known and are based on the selective sintering of polymer particles, layers of polymer particles being briefly exposed to laser light, and the polymer particles exposed to the laser light being thus bonded to one another. Three-dimensional objects are produced via successive sintering of layers of polymer particles. Details of the selective laser sintering process are found by way of example in the specifications U.S. Pat. No. 6,136,948 and WO 96/06881.

Other processes with good suitability are the SIB process, as described in WO 01/38061, or a process as described in EP 1015 214. Both processes operate with full-surface infrared heating to melt the polymer. Selectivity of melting is achieved in the first via application of an inhibitor and in the second process via a mask. DE 103 11 438 describes another process. In this, the energy needed for melting is introduced via a microwave generator, and selectivity is achieved via application of a susceptor.

Other suitable processes are those which operate with an absorber, either present in the powder or applied by inkjet methods, as described in DE 10 2004 012 682.8, DE 10 2004 012 683.6, and DE 10 2004 020 452.7.

A feature of the inventive shaped products produced by a layer-by-layer process by selectively melting regions is that they have used powder which has been produced from a dispersion which comprises at least one polymer component and one water-soluble auxiliary component, where the auxiliary component in turn comprises at least one oligosaccharide.

The shaped products can moreover comprise fillers and/or auxiliaries (the statements made for the polymer powder being applicable here), e.g. heat stabilizers, e.g. sterically hindered phenol derivatives. Examples of fillers can be glass particles, ceramic particles, and also metal particles, e.g. iron shot, or corresponding hollow beads. The inventive shaped products preferably comprise glass particles, very particularly preferably glass beads. Inventive shaped products preferably comprise less than 3% by weight, particularly preferably from 0.001 to 2% by weight, and very particularly preferably from 0.05 to 1% by weight, of these auxiliaries, based on the entirety of the polymers present. Inventive shaped products likewise preferably comprise less than 75% by weight, preferably from 0.001 to 70% by weight, particularly preferably from 0.05 to 50% by weight, and very particularly preferably from 0.5 to 25% by weight, of these fillers, based on the entirety of the polymers present.

There are application sectors for these shaped products both in rapid prototyping and in rapid manufacturing. The latter certainly means short runs, i.e. production of more than one identical part, for which however production by means of an injection mold is uneconomic. Examples of these are parts for high-specification cars of which only small numbers are produced, or replacement parts for motor sports, in which the important factor is not only the small numbers but also the availability time. Industries using the inventive parts can be the aerospace industry, medical technology, mechanical engineering, car production, the sports industry, the household goods industry, the electrical industry, and the lifestyle sector.

Melting points were determined by means of DSC (differential scanning calorimetry) to DIN 53765, or to AN-SAA 0663. The measurements were made using a Perkin Elmer DSC 7, using nitrogen as flushing gas and a heating rate and cooling rate of 20 K/min. The measurement range was −90 to +250° C.

The solution viscosity for the examples here is determined to DIN EN ISO 307 in 0.5% strength m-cresol solution.

Bulk density was determined using an apparatus to DIN 53 466.

The laser-diffraction values measured were obtained on a Malvern Mastersizer S, Ver. 2.18.

Having generally described this invention, a further understanding can be obtained by reference to certain specific examples which are provided herein for purposes of illustration only, and are not intended to be limiting unless otherwise specified.

### EXAMPLES

### Comparative Example 1

Polymer Powder According to DE 10 2005 008 044.8, Block Polyetheramide

A 200 1 two-vessel polycondensation system—composed of batch container with anchor stirrer and polycondensation reactor with helical stirrer—was supplied with the following starting materials for preparation of PEA based on PA12 with hard block of 1068 dalton and Jeffamine D2000:
1st Charge:
28.797 kg of laurolactam,
   7.547 kg of dodecanedioic acid, and also
   2nd Charge:
67.509 kg of Jeffamine D2000,
100.0 g of a 50% strength aqueous solution of hydrophosphorous acid (corresponding to 0.05% by weight).

The starting materials of the 1st charge were melted at 180° C. under nitrogen, charged under pressure to the polycondensation reactor, and heated to about 280° C. for 6 hours in the sealed autoclave, with stirring. During this period, the 2nd charge was preheated to 180° C. in the batch container and charged under pressure to the oligoamide-dicarboxylic-acid melt in the polycondensation reactor. After depressurization to atmospheric pressure, this mixture at 220° C. is kept at this temperature for about 6 hours in the stream of nitrogen, with stirring. Within a period of 2 hours, a 100 mbar vacuum is then applied and maintained until the desired torque has been achieved. The melt was then subjected to 10 bar of nitrogen pressure and discharged by means of a gear pump and strand-pelletized. The pellets were dried at 80° C. under nitrogen for 24 hours.

Output: 92 kg

The Properties of the Product were as Follows:

Crystallite melting point Tₘ: 153° C.
Relative solution viscosity ηᵣₑₗ: 1.60
COOH end groups: 11 mmol/kg
NH₂ end groups: 42 mmol/kg

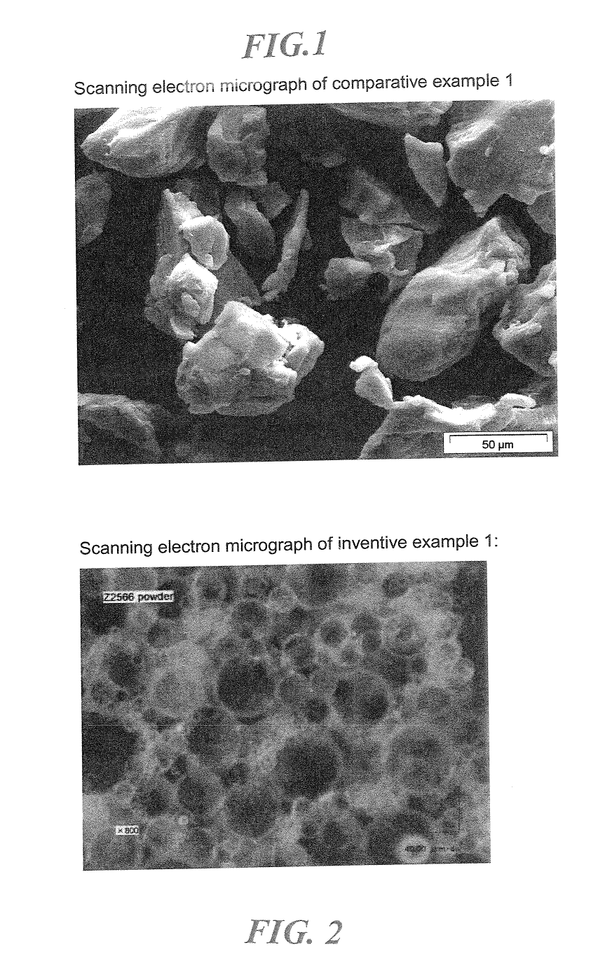

As shown by the scanning electron micrograph (FIG. 1), the particles are very sharp-edged.

### Comparative Example 2

Polymer Powder to DE 10 2005 008 044.8, Block Polyetheramide A 100 I two-vessel polycondensation system—composed of batch container with anchor stirrer and polycondensation reactor with helical stirrer—was supplied with the following starting materials for preparation of PEA based on PA12 with hard block of 7225 dalton and Jeffamine D400:

1st Charge. 43.566 kg of laurolactam, 1.434 kg of dodecanedioic acid, and also

2nd Charge: 2.938 kg of Jeffamine D400, 47.0 g of a 50% strength aqueous solution of hydrophosphorous acid (corresponding to 0.05% by weight).

The starting materials of the 1 st charge were melted at 180° C. under nitrogen, charged under pressure to the polycondensation reactor, and heated to about 280° C. for 6 hours in the sealed autoclave, with stirring. During this period, the 2nd charge was preheated to 180° C. in the batch container and charged under pressure to the oligoamide-dicarboxylic-acid melt in the polycondensation reactor. After depressurization to atmospheric pressure, this mixture at 230° C. is kept at this temperature for about 6 hours in the stream of nitrogen, with stirring. Within a period of 2 hours, a 100 mbar vacuum is then applied and maintained until the desired torque has been achieved. The melt was then subjected to 10 bar of nitrogen pressure and discharged by means of a gear pump and strand-pelletized. The pellets were dried at 80° C. under nitrogen for 24 hours.

Output: 44 kg

The Properties of the Product were as Follows:

Crystallite melting point Tₘ: 173.4° C.
Relative solution viscosity ηᵣₑₗ: 1.84
COOH end groups: 38 mmol/kg NH₂ end groups: 39 mmol/kg

### Inventive Example 1

Further use was made of the pellets from Comparative example 2. 35 parts thereof were used. 45 parts of an oligosaccharide (PO-10 from Towa Chemical Industries) and 20 parts of penthaerythritol were also added. The material was kneaded for 10 minutes at 170° C. in a laboratory kneader; the mixture was then kept at 30° C. for a further 8 minutes. After cooling, the components are separated from one another with the aid of water via solution of the oligosaccharide. The bulk density of the polymer powder obtained after drying is 362 g/l, and its grain size distribution D₁₀/D₅₀/D₉₀ is 18/54/114 μm. The BET surface area is less than 1 g/m². The melting point is 153° C. 27 mmol/kg of amino end groups and 15 mmol/g of carboxy groups are detectable. As shown by the scanning electron micrograph (FIG. 2), the particles are very round.

### Inventive Example 2

Further use was made of the pellets from Comparative example 2. 22 parts thereof were used. 58 parts of an oligosaccharide (PO-10 from Towa Chemical Industries) and 20 parts of penthaerythritol were also added. The material was kneaded for 5 minutes at 200° C. in a laboratory kneader; the mixture was then kept at 30° C. for a further 10 minutes. After cooling, the components are separated from one another with the aid of water via solution of the oligosaccharide. The bulk density of the polymer powder obtained after drying is 532 g/l, and its grain size distribution D₁₀/D₅₀/D₉₀ is 18/45/91 μm. The BET surface area is less than 1 g/m². The melting point is 174° C. 22 mmol/kg of amino end groups and 54 mmol/g of carboxy groups are detectable.

Milling of Pellets:

The materials from Comparative examples 1 and 2 were milled at −40° C. The mill used is a Hosokawa Alpine 160 C Contraplex pinned-disk mill.

The powders were sieved at 100 μm to ensure that no excessively coarse particles could disrupt the construction process.

Processing:

All of the powders were subjected to a construction process in an EOSINT P360 from EOS GmbH, Krailling. This is a laser sintering machine. The construction chamber was preheated to a temperature close to the melting point of the respective specimen. The laser parameters, such as frequency and power, were in each case adjusted appropriately for the material by trials. The non-inventive materials were markedly more difficult to process, in particular with respect to groove-free application of each powder layer, and therefore with respect to ease of automation.

All of the powders from the examples were provided with 0.1 part of Aerosil 200 in a dry blend in a MTI M20 mixer at 400 rpm.

| | Modulus of | Tensile | Tensile strain | RT notched | −30 notched | |
|---|---|---|---|---|---|---|
| | elasticity | strength | at break | impact | impact | Density |
| | N/mm² | N/mm² | % | kJ/m² | kJ/m² | g/mm³ |
| Comparative | 87 | 9 | 190.9 | No fracture | No fracture | 0.86 |
| example 1 | | | | | | |
| Comparative | 1323 | 41.4 | 8.7 | 3.1 | 5.7 | 0.78 |
| example 2 | | | | | | |
| Inventive | 84 | 7.5 | 60.9 | 35 | | 0.95 |
| example 1 | | | | | | |
| Inventive | 1125 | 40.6 | 12.3 | 3 | 3.8 | 0.94 |
| example 2 | | | | | | |

In particular, the density of the test specimens produced according to the present invention is close to the density of the polymer itself. There are markedly fewer defects and cavities observable in the component. In the soft formulations (Comparative example 1 and Inventive example 1), this has a less severe effect on the other mechanical properties; the 20 harder the material, the greater the fall-off in these when the number of cavities in the component increases. The round grains have a very favorable effect on the construction process and on component quality. The powder from the comparative examples cannot be precipitated.

German patent application 10 2006 005 500.4 filed Feb. 7, 2007, is incorporated herein by reference.

Numerous modifications and variations on the present invention are possible in light of the above teachings. It is therefore to be understood that within the scope of the appended claims, the invention may be practiced otherwise than as specifically described herein.

1. A process for the layer-by-layer moldless production of three-dimensional shaped products, comprising:
providing at least one powder layer,
selective melting of regions of the respective powder layer via input of electromagnetic energy,
wherein said powder of said powder layer comprises at least one polymer powder or copolymer powder produced from a dispersion which comprises at least one polymer or copolymer and which comprises a water-soluble component,
said water-soluble component comprising at least one oligosaccharide.

2. The process as claimed in claim 1, wherein the polymer or copolymer has been produced via polymerization, polycondensation, polyaddition, or from natural substances.

3. The process as claimed in claim 1, wherein the polymer or copolymer comprises a thermoplastic, a thermoset, an elastomer, or a combination thereof.

4. The process as claimed in claim 1, wherein the polymer or copolymer comprises at least one unit selected from the group consisting of polyesters, copolyesters, polyamides, copolyamides and mixtures thereof.

5. The process as claimed in claim 1, wherein the polymer or copolymer comprises at least one unit selected from the group consisting of polysulfones, polyaryl ether ether ketones, polyimide and mixtures thereof.

6. The process as claimed in claim 1, wherein the polymer or copolymer comprises at least one unit selected from the group consisting of polycarbonate, PMMA, PMMI and mixtures thereof.

7. The process as claimed in claim 1, wherein a ratio by weight of the polymer component to the water-soluble component in the dispersion is from 1:99 to 35:60.

8. The process as claimed in claim 1, wherein a BET surface area of the powder as measured according to DIN ISO 9277 is smaller than or equal to 10 m²/g.

9. The process as claimed in claim 1, wherein a BET surface area of the powder as measured according to DIN ISO 9277 is smaller than or equal to 3 m²/g.

10. The process as claimed in claim 1, wherein a BET surface area of the powder as measured according to DIN ISO 9277 is smaller than or equal to 1 m²/g.

11. The process as claimed in claim 1, wherein a median grain diameter of the powder is from 10 to 120 μm.

12. The process as claimed in claim 1, wherein a median grain diameter of the powder is from 35 to 100 μm.

13. The process as claimed in claim 1, wherein a median grain diameter of the powder is from 40 to 70 μm.

14. The process as claimed in claim 1, wherein a bulk density of the powder as measured according to DIN 53466 is from 300 to 600 g/l.

15. The process as claimed in claim 1, wherein a d90:d10 grain size distribution of the powder is from 3:1 to 15:1.

16. The process as claimed in claim 1, wherein the powder comprises auxiliaries and/or fillers.

17. The process as claimed in claim 1, wherein the powder comprises powder-flow aids.

18. The process as claimed in claim 16, wherein said filler comprises inorganic particles.

19. The process as claimed in claim 1, wherein the powder comprises organic and/or inorganic pigments.

20. The process as claimed in claim 1, wherein the powder comprises carbon black.

21. The process as claimed in claim 1, wherein the powder comprises titanium dioxide.

22. A shaped product, produced via the processes according to claim 1.
